(19) United States
(12) Patent Application Publication
(10) Pub. No.: US 2005/0086327 A1
(43) Pub. Date: Apr. 21, 2005

(54) Method and apparatus by which a UE starts compression in SIP signalling to IMS

(76) Inventors: Georg Mayer, Espoo (FI); Hisham Khartabil, Helsinki (FI); Robert Sugar, Budapest (HU); Paulius Meskauskas, Espoo (FI)

Correspondence Address: Ware, Fressola, Van Der Sluys and Adolphson, LLP;Five Bradford Green Building, 755 Main Street, P. O. Box 224, Monroe, CT, 06468, US

(21) Appl. No.: 10/687,533

(22) Filed: Oct. 16, 2003

(51) Int. Cl. G06F 15/16

(52) U.S. Cl. 709/219; 709/246

(57) ABSTRACT

A method (and corresponding equipment) by which a UE device (10) begins compressing messages it transmits to an SIP outbound proxy server (12) as SIP signals, including: a step (22a) in which the UE device sends a request message (22a 32a 42a) to the SIP outbound proxy server (12); and a step (23 33 43) in which the UE device analyzes a response message (22b 32b 42b) received from the SIP outbound proxy server (12) in response to the request message (22a 32a 42a) to determine a compression parameter. The request message (22a) may be an options request message and the response message (22b) would then be e.g. a 200 OK message. Alternatively, the request message (32a) may be a register message, and the response message (32b) would then be e.g. a 401 (unauthorized) message. In another embodiment, the response message (42b) is any compressed message.

### TECHNICAL FIELD

The present invention pertains to the field of telecommunications. More particularly, the present invention pertains to use of SIP signalling between telecommunication devices in a telecommunications network, and in particular to the use of compression of messages sent via SIP signalling from a telecommunications device to a proxy server of a 3GPP IP Multimedia Subsystem.

### BACKGROUND ART

The present invention concerns Session Initiation Protocol (SIP) signalling for communication of multimedia via an Internet Protocol (IP) Multimedia Subsystem (IMS) provided as part of 3GPP (Third Generation Partnership Program) UMTS (Universal Mobile Telecommunications System) networks. A telecommunications terminal—called here a user equipment (UE) device—would for example communicate with an IMS network in case of attempting to access content of a server connected to the Internet. In such an application, the UE device (such as a mobile phone) would access IMS—provided by a network operator as part of an overall telecommunications network—via a radio access network (RAN) (and more specifically for example a RAN according to 3GPP providing packet service), and a server of IMS would then serve as a link to the Internet server having the content sought by the UE device. The RAN and the IMS network can be connected in various ways by elements of what is called a core network of the overall telecommunications network.

SIP is defined by the IETF (Internet Engineering Task Force) in RFC (Request for Comment) 3261 and is an application-layer protocol used for (among other things) establishing, handling and releasing end-to-end multimedia sessions via IMS, which makes possible (via control signalling) providing multimedia content according to IP via the packet-switched domain (vs. the circuit-switched domain) of UMTS.

IMS is set out in various 3GPP specifications including 3GPP Technical Specification (TS) 23.228, “IP Multimedia Subsystem (IMS); Stage 2” (as well as 3gPP TS 24.228 and 24.229). The IMS includes all UMTS core network elements used to provide multimedia services, including the collection of signalling and bearer related network elements defined in 3GPP TS 23.002. The IMS includes various related CSCF (call state control function) elements, which in combination provide functionality for routing packets conveying multimedia information. Signalling (for setting up end-to-end communications) between a wireless terminal/UE device and IMS is according to SIP, with the UE device including what is called a SIP user agent responsible for such signalling at the UE end.

For communication according to SIP with IMS, signalling compression can often be used, i.e. the content/payload of a SIP message can be compressed using one or another compression technique, such as SigComp, which is set out in RFC 3320. In particular, a UE device can use signalling compression in communicating with a P-CSCF (proxy CSCF) (a logical entity as opposed to necessarily a distinct hardware and software component) of IMS, and usually included as part of the functionality of what is called a first-hop proxy server of IMS or, alternatively, what is called the SIP outbound proxy server of IMS. 3GPP TS 24.229 states that the P-CSCF/UE shall start signalling compression (per e.g. SigComp) after establishing a security association (a so-called IPSec Security Association) using e.g. IMS AKA (IMS Authentication and Key Agreement) as described e.g. in 3GPP TS 33.203 v2.0.0. Starting (signaling) compression after establishing a security association is not in line with (in accord with) the procedure for starting compression according to RFC 3486, which states that a request is only compressed when the next hop (identified either by the topmost Route header entry or, if no Route header present, by the request URI) URI includes the parameter “;comp=SigComp”; and, on the other hand, a response is only compressed when the so-called Via header entry of the next hop includes that same parameter.

In order to align 3GPP TS 24.229 with RFC 3486, 3GPP TS 24.229 is proposed to be changed so as to state that a UE and P-CSCF shall start using compression according to the procedures for starting compression set out in RFC 3486. This has the disadvantage that initial requests sent from a UE are not compressed, since according to RFC 3486 compression is not to be started until the next hop URI includes the parameter “;comp=SigComp,” and the SIP-URI of the P-CSCF (Outbound Proxy) does not include that parameter. The P-CSCF address is discovered by a UE device during initial registration procedure with IMS—either via DHCPv6 or during signalling PDP (packet data protocol) context establishment from the GGSN (gateway GPRS (General Packet Radio Service) support node)—and does not change afterwards.

By way of background, according to 3GPP TS 24.229 as it is now: initial requests sent to the UE (by P-CSCF) are sent compressed, since the UE registers with the “;comp=SigComp” parameter in the Contact header; subsequent requests within a dialog are sent to the UE compressed, since the UE sends the “;comp=SigComp” parameter in the Contact header of the initial request (e.g. INVITE, SUBSCRIBE); subsequent requests within a dialog sent from the UE are sent compressed, since those requests are routed based on a Record-Route/Route entry of the P-CSCF; responses from the UE are sent compressed, since the P-CSCF indicates the comp-parameter in its Via header of the request; and responses to the UE are sent compressed, since the UE indicates the comp-parameter in its Via header entry of the request.

So what is needed is a protocol in line with RFC 3846 according to which a UE starts compressing messages it signals to IMS using SIP, and ideally, a protocol by which a UE device does the compressing using a compression mechanism signaled by the IMS so that any one of several alternative compression mechanisms might be used, depending on the IMS.

### DISCLOSURE OF THE INVENTION

Accordingly, in a first aspect of the invention, a method is provided by which a UE device begins compressing messages it transmits to an SIP outbound proxy server as SIP signals, the method characterized by: a step in which the UE device sends a request message to the SIP outbound proxy server; and a step in which the UE device analyzes a response message received from the SIP outbound proxy server in response to the request message to determine a compression parameter for use in compressing messages it sends to the SIP outbound proxy server.

In accord with the first aspect of the invention, the request message may be an options request message and the response message may be a 200 OK message, and further, in the step in which the UE device analyzes the response message, the UE device may parse the response message to obtain the compression parameter.

Also in accord with the first aspect of the invention, the method may be further characterized by: a step in which the UE device alters an address for the SIP outbound proxy server previously stored so as to include the stored address the compression parameter.

Also in accord with the first aspect of the invention, the request message may be a register message, and the response message may be a 401 (unauthorized) message.

Also in accord with the first aspect of the invention, the response message may be any compressed message.

In a second aspect of the invention, an apparatus is provided operative according to a method provided by the first aspect of the invention.

In a third aspect of the invention, a computer program product is provided comprising: a computer readable storage structure embodying computer program code thereon for execution by a computer processor in a UE device, with said computer program code characterized in that it includes instructions for performing the steps of a method according to the first aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of an IMS network and a UE communicating according to the invention; and

FIG. 2 is message sequence diagram/flow chart illustrating a sequence of steps according to the invention by which a UE device starts compressing messages it sends to IMS, a sequence of steps in accord with RFC 3846.

FIGS. 3 and 4 are message sequence diagrams/flow charts illustrating other sequences of steps according to the invention by which a UE device starts compressing messages it sends to IMS, sequences not in accord with RFC 3846.

### BEST MODE FOR CARRYING OUT THE INVENTION

The invention is described below in the context of a wireless terminal communicating with the IMS of a 3G network, i.e. per a UMTS network according to the 3GPP.

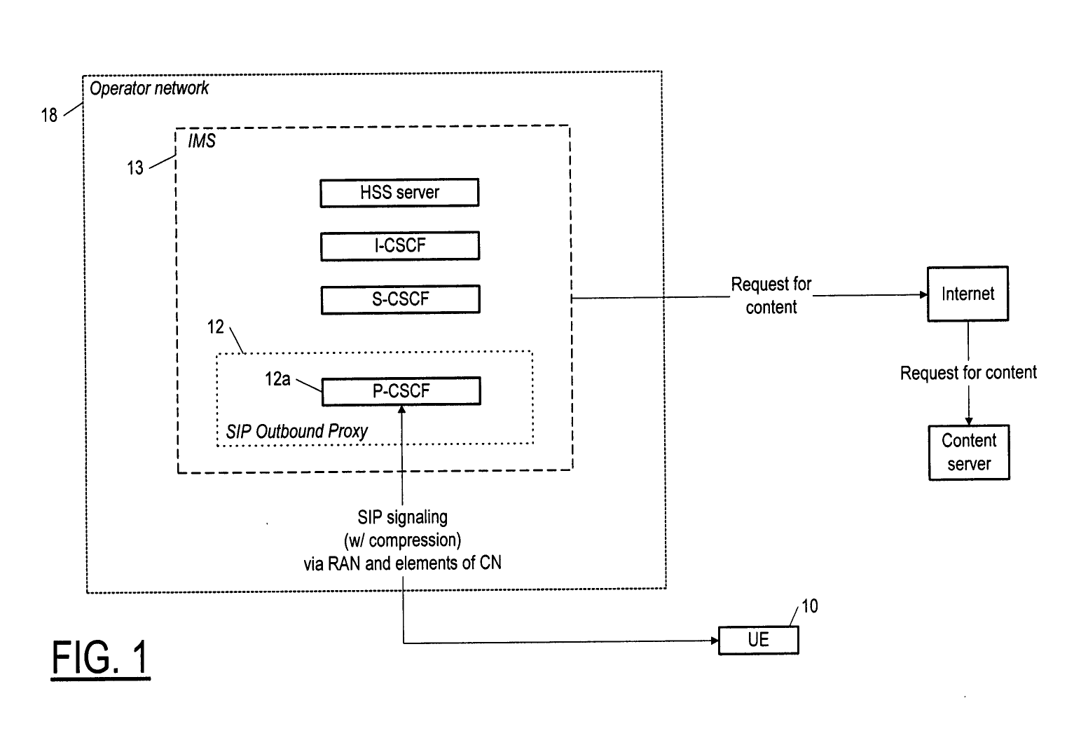

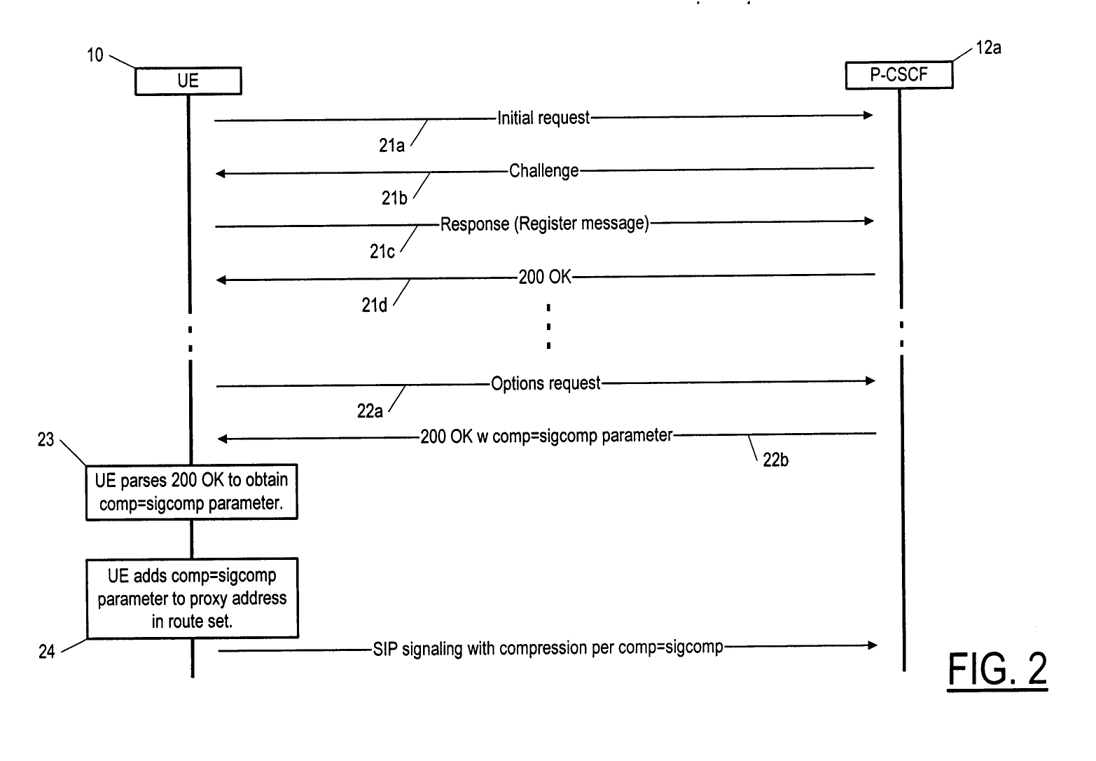

Referring now to FIGS. 1 and 2, according to the invention, in order to commence compressing the payloads of messages it sends using SIP signalling to the IMS 13 of an operator network 18 (assumed here to be the operator network to which the UE is subscribed), the SIP user agent (not shown) of a UE device 10 exchanges SIP messages, via a radio access network (RAN) (not shown), with an SIP outbound proxy server 12 (the first hop proxy server) of the IMS 13 having P-CSCF functionality 12a, as follows (after discovering the IP address of the SIP outbound proxy server during initial registration procedures either via DHCPv6 or during signalling PDP context establishment from the GGSN):

First the UE device 10 and the P-CSCF 12a exchange a sequence of messages 21a-d resulting in establishing a security association between the UE device 10 and the P-CSCF 12a (or more properly, the SIP outbound proxy server 12), a series of messages such as defined by the challenge and response IMS AKA protocol. The series of messages establishing the security association includes two messages sent by the UE device 10, and these messages are sent as in the prior art, i.e. uncompressed.

Next, and now according to the invention, in order to be able to start compressing payloads of subsequent SIP messages according to a procedure compatible with RFC 3846, the UE 10 then sends an OPTIONS request 22a to the P-CSCF 12a. (An OPTIONS request is used to query a SIP entity as to the options (SIP extensions) it supports; the SIP entity responds to an OPTIONS request with a list of the options it supports, as set out in RFC 3261 (SIP).) According to standard SIP signalling, the P-CSCF 12a answers an OPTIONS request (message) with a 200 OK response 22b, having a contact header including contact information—i.e. an IP address—for the P-CSCF, and also including a parameter indicating whether the P-CSCF supports (and so allows) compression; that parameter is included using the text “comp=sigcomp” in the contact header, where “sigcomp” indicates a particular type of compression (i.e. a type the P-CSCF supports). Now, and once again according to the invention, in a step 23, the UE device 10 parses the 200 OK response 22b to obtain the compression parameter, and in a next step 24, the UE device replaces the IP address for the SIP outbound proxy server 12 it has stored in a pre-loaded route set—i.e. the address it discovered during initial registration) in order to first communicate with the proxy 12—with the address received in the contact header of the 200 OK message, an address that points to the same SIP outbound proxy server 12 as before, but that includes the “comp=sigcomp” parameter, where the original address did not. Instead of actually replacing the address, the UE device may simply alter the address by appending the compression parameter to the address; in any event, the final result is the same, whether the address originally on file is replaced or simply altered to include the compression parameter. The replaced address is here called the proxy base IP address, and the replacing/finally altered address is here called the proxy IP address with compression parameter.

Once the replacement/alteration is made, and until the UE device 10 in effect logs out (terminates its SIP session with the SIP outbound proxy server 12), the UE device 10 is allowed (according to RFC 3846) to compress all further requests since the address of the proxy 12 in the route set for every initial request (i.e. for every initial request to a new final destination but via the same proxy 12) will include the comp=sigcomp parameter. After the UE device 10 logs out with the proxy 12, the UE device puts the proxy base IP address back in the route set (i.e. in essence it deletes the compression parameter from the address it has in the route set for the proxy), and in any future SIP session via the proxy 12, the UE device again carries out the above procedure of sending an options request and obtaining the compression parameter from the 200 OK response, a compression parameter that may, according further to the invention, indicate a compression mechanism other than that indicated by “sigcomp.” In other words, the invention makes it possible for an SIP outbound proxy server to indicate dynamically to a UE device that one or another of several possible compression mechanisms be used.

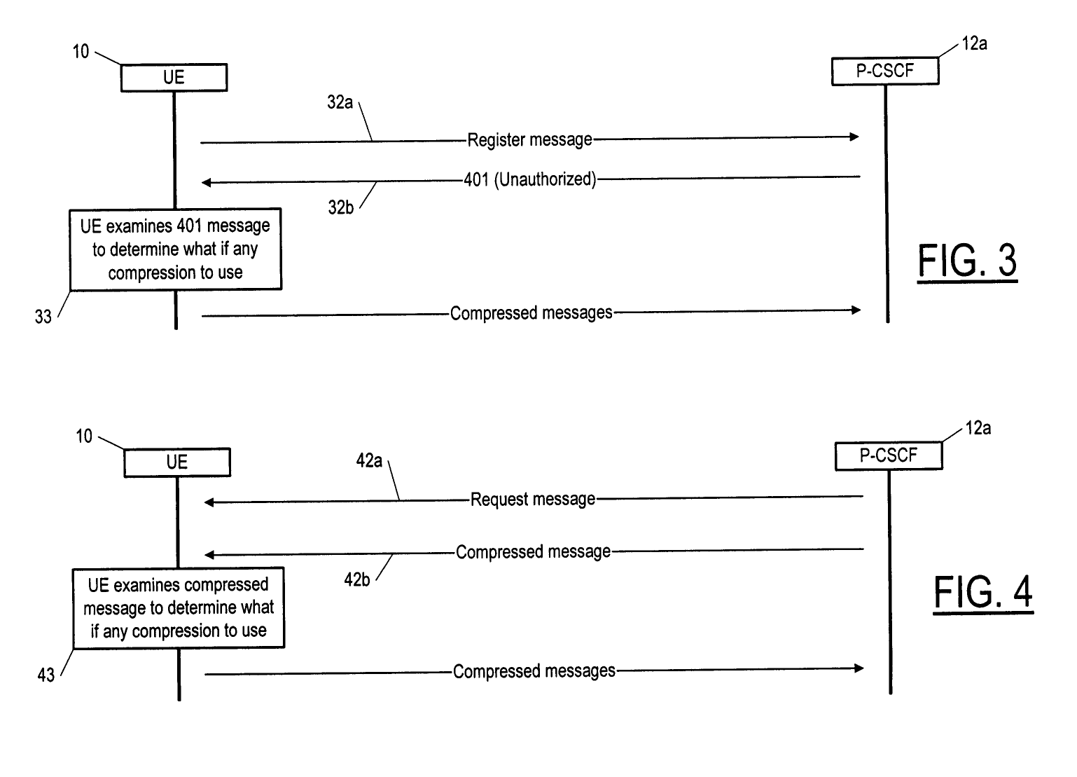

Referring now to FIGS. 3 and 4, in alternative embodiments, but embodiments not aligned with RFC 3486 as it currently stands, the UE device 10 determines whether the P-CSCF 12a supports compression, and also determines at least one type of compression the P-CSCF supports, by either (FIG. 3) sending a register message 32a prompting a 401 (Unauthorized) response 32b from the P-CSCF 12a and then performing a step 33 of examining the response to determine what if any compression to use, or (FIG. 4) by sending one or another request message 42a and receiving any compressed message 42b from the P-CSCF 12a and then performing a step 43 of examining the message to determine what if any compression can be used. Once the UE device 10 learns whether and what type of compression is supported, it can send all further messages to the P-CSCF 12a compressed or not compressed, accordingly.

The invention has been described in terms (essentially) of the steps of a method (in connection with the description of the message sequence diagram/flow chart of FIGS. 2-4). The invention also comprehends an apparatus for performing the above-described steps. Thus, for each step described above, there can be a corresponding module of an apparatus, although it is also possible for the functionality for performing more than one of the above-described steps to be incorporated into a single module. Such modules may be implemented as hardware, or may be implemented as software or firmware for execution by a processor. In particular, in the case of firmware or software, the invention is provided as a computer program product including a computer readable storage structure embodying computer program code—i.e. the software or firmware—thereon for execution by a computer processor provided with the UE device 10.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method by which a UE device (10) begins compressing messages it transmits to an SIP outbound proxy server (12) as SIP signals, the method characterized by:
a step (22a) in which the UE device sends a request message (22a 32a 42a) to the SIP outbound proxy server (12); and
a step (23 33 43) in which the UE device analyzes a response message (22b 32b 42b) received from the SIP outbound proxy server (12) in response to the request message (22a 32a 42a) to determine a compression parameter for use in compressing messages it sends to the SIP outbound proxy server (12).

2. The method of claim 1, wherein the request message (22a) is an options request message and wherein the response message (22b) is a 200 OK message, and further wherein in the step (23) in which the UE device (10) analyzes the response message (22b), the UE device (10) parses the response message to obtain the compression parameter.

3. The method of claim 1, further characterized by:
a step (24) in which the UE device (10) alters an address for the SIP outbound proxy server (12) previously stored so as to include the stored address the compression parameter.

4. The method of claim 1, wherein the request message (32a) is a register message, and wherein the response message (32b) is a 401 (unauthorized) message.

5. The method of claim 1, wherein the response message (42b) is any compressed message.

6. An apparatus used by a UE device (10) to begin compressing messages it transmits to an SIP outbound proxy server (12) as SIP signals, the apparatus characterized by:
means (22a) by which the UE device sends a request message (22a 32a 42a) to the SIP outbound proxy server (12);
means (23 33 43) by which the UE device analyzes a response message (22b 32b 42b) received from the SIP outbound proxy server (12) in response to the request message (22a 32a 42a) to determine a compression parameter for use in compressing messages it sends to the SIP outbound proxy server (12).

7. The apparatus of claim 6, wherein the request message (22a) is an options request message and wherein the response message (22b) is a 200 OK message, and further wherein the means (23) by which the UE device (10) analyzes the response message (22b) includes means by which the UE device (10) parses the response message to obtain the compression parameter.

8. The apparatus of claim 6, further characterized by:
means (24) by which the UE device (10) alters an address for the SIP outbound proxy server (12) previously stored so as to include the stored address the compression parameter.

9. The apparatus of claim 6, wherein the request message (32a) is a register message, and wherein the response message (32b) is a 401 (unauthorized) message.

10. The apparatus of claim 6, wherein the response message (42b) is any compressed message.

11. A computer program product comprising: a computer readable storage structure embodying computer program code thereon for execution by a computer processor in a UE device (10), with said computer program code characterized in that it includes instructions for performing the steps of the method of claim 1.
